(19) United States
(12) Patent Application Publication
(10) Pub. No.: US 2008/0023040 A1
(43) Pub. Date: Jan. 31, 2008

(54) Methods and Systems For Operating Large Hydrocarbon Storage Facilities

(75) Inventor: John C. Hancock, Port Isabel, TX (US)

Correspondence Address: GROOVER & Associates, BOX 802889, DALLAS, TX, 75380-2889, US

(73) Assignee: JR & JH Holdings, LLC, Houston, TX (US)

(21) Appl. No.: 11/745,336

(22) Filed: May 7, 2007

Related U.S. Application Data
(60) Provisional application No. 60/798,373, filed on May 5, 2006.
(60) Provisional application No. 60/897,977, filed on Jan. 29, 2007.

(51) Int. Cl. B08B 9/093; B08B 9/08

(52) U.S. Cl. 134/22.18

(57) ABSTRACT

Methods and systems for operating a facility which stores large quantities of petroleum. When the large storage tanks need cleaning or sludge abatement, the sludge from the interior of storage tanks is mobilized using a metered flow agent stream, and then subjected to a mechanical comminution or high shear action, e.g. by grinding or chopping. This produces a pumpable slurry which is then recirculated back into the tank to further mobilize sludge. This cleaning technique results in a faster cleaning process. This also provides a process which is less exposed to uncertainties in the composition of the sludge, e.g. to how much rust or scale is present in the sludge. Since the duration of downtime for cleaning is shorter AND less uncertain, tank cleaning can be scheduled into smaller schedule gaps, resulting in less capital cost (for downtime) and lower maintenance budget overall (since developing leakage problems can be caught sooner). This process also reduced discharge, and hence imposes less environmental burden. This means that the facility as a whole provides more environmentally friendly operation.

### CROSS-REFERENCE TO RELATED APPLICATIONS

This application claims priority from U.S. Provisional Patent Applications 60/798,373 filed on May 5, 2006, entitled “Method of Processing and Removing Hydrocarbon Residues from a Tank”, of John C. Hancock, and 60/897,977 filed on Jan. 29, 2007, entitled “Hydrocarbon Tank Cleaning Methods and Systems”, also of John C. Hancock, which are both herein incorporated by reference in their entirety.

### BACKGROUND AND SUMMARY OF THE INVENTION

The present disclosure is directed to cleaning methods and systems for hydrocarbon storage systems, and more particularly, but not by way of limitation, to petroleum oil storage tanks in which petroleum-based or other sludges have settled or precipitated on the surfaces of the tank as sludge.

The following paragraphs contain some discussion which is illuminated by the innovations disclosed in this application, and any discussion of actual or proposed or possible approaches in these paragraphs does not imply that those approaches are prior art.

Sludge

Hydrocarbon based oils used in all sectors of the petroleum and petrochemical industry are often stored in tanks. Such storage occurs in crude oil and gas production, refineries, petrochemical plants, bulk plants, and terminals. Typical petroleum storage tanks will have a diameter from 100 to 400 feet and heights of 20 to 50 feet or more.

Over time, “sludge” forms in the bottom of these tanks. Sludge is a mixture of deposits, with a composition which varies from tank to tank. The composition of the sludge will depend upon the composition of the oil or oils that have been stored in a particular tank and/or the refining or petrochemical process associated with the tank.

A variety of materials contribute to sludge. In general, sludge can be formed from (for example) various combinations or proportions of naturally occurring sediments, higher molecular weight hydrocarbons, and entrained water, as well as rust scales from piping and tank walls, inorganic debris from coatings, other inorganic debris from internal equipment and sampling operations, and process solids. Sludge is formed when these components are separated by gravity from the volume of liquid hydrocarbons in the storage tank. This multitude of combinations form a wide variety of thixotropic sludge types consisting of inorganic and organic materials that include but are not limited to: organic resins, asphaltenes, paraffin, heavy hydrocarbons, light hydrocarbons, rust particles, rust scales, mineral sediments, refining or petrochemical process solids, catalyst fines, pyrophoric iron sulfide deposits, glass bottles, soft lines, coating particles, coating scales, rags, gloves, cloth straps, plastics, styrene strings, bolts, iron pipe fittings, iron pipe connections, rocks, gravel, hard lines, tools, and metal straps.

Over time, the heavier elements in the stored oil will continue to migrate to the bottom of the tank and enter the sludge. As these heavier components concentrate, the sludge becomes more viscous, loses its flow characteristics, and (depending upon its composition) may even solidify. Since a large tank can hold a million barrels or more, and the volume which passes through a tank in the years between cleanings can be a large multiple of the tank volume, the sludge can accumulate sludges from an enormous volume of oil.

Sludge Removal

Sludge removal or tank cleaning is required when sludge buildup interferes with or reduces the efficiency of the storage tank operation. Sludge removal or tank cleaning may also be required prior to the performance of a tank maintenance procedure, repair, modification or inspection.

All conventional techniques used to remove tank bottoms sludge from hydrocarbon storage tanks, while richly varied, can be classified under just two general methods—“Sludge Fluidization/Removal Method” and “Sludge Excavation/Removal Method”. The two Methods are similar in their need to overcome the wide array of physical and chemical characteristics associated with tank bottoms sludge that make it difficult to remove, such as high surface tension, agglomerated or solidified organic fractions, high organic and inorganic solids, and poor or nonexistent flow characteristics.

Conversely, the two Methods are distinctively different in the means by which removal of sludge from the tank is accomplished.

Sludge Fluidization

The primary method used for the removal of sludge is the Sludge Fluidization/Removal Method. In general, this method relies on the use of a liquid to fluidize the sludge for removal. The most common conventional iteration of this method is known as the “Cutter Stock” technique. The Cutter Stock technique is based on the use of a large quantity of low viscosity hydrocarbon liquid, heated or at ambient temperature, to mix into the sludge, reduce sludge viscosity, modify surface tension and thereby disperse the sludge throughout the carrier fluid to effect removal. In general this method relies on large quantities of heated or ambient temperature diluent or cutter stock (various types of light oils such as diesel oil, light cycle oil, or light crude oil) being added into the tank and to the sludge at a ratio of cutter stock to sludge ranging from 1:1 up to 20:1 depending on tank bottom conditions and the specific iteration of the cutter stock method used. The heated or ambient temperature cutter stock is used as a carrier fluid to partially solubilize the organic fraction of the sludge while reducing the viscosity of the sludge through temperature and volumetric fluid dilution. The inefficiencies of cutter stock as a carrier fluid for sludge are partially offset by the high volume ratio of cutter stock to sludge. The mechanically dispersed sludge in the high volume of cutter stock is then subsequently removed via conventional pumping methods.

Sludge removal typically involves the delivery of cutter stock to the in-situ sludge by use of a centrifugal pump and through a fixed lance or nozzle, a manually articulated lance or nozzle, or a robotic device inside the tank shell in order to disperse the sludge throughout the cutter stock for stripping by centrifugal or sludge pumps until suction is lost. The ratio of cutter stock to sludge ranges from 1:1 to 20:1 (cutter stock at 1.0 to 20.0 times the volume of the sludge).

After these operations have gone as far as they can, a substantial amount of rust, scale and debris will typically be present on the tank. This cannot be easily removed by the cutter stock method alone. The sludge remaining after the completion of this step is considered residual sludge.

Residual sludge is similarly dispersed and removed by further manual or robotic injection of heated or ambient temperature cutter stock and/or diesel or light cycle oil inside the tank. Sludge is manually pushed to sludge pumps positioned inside the tank and/or at the sump. Sludge that contains rust scale or other large debris must be manually removed by shovels or manually/mechanically removed by Air Vac trucks into Vacuum boxes for removal and disposal by owner.

Floor/Wall Cleaning is generally accomplished by use of diesel or other light cycle oil and manual scrubbing to remove sticky sludge attached to these surfaces. Scrapers may be required. Filters will be required for rust scale and other debris.

Deoiling can be done by use of a soap injection pump and manual scrubbing followed by a wash with a high pressure fire hose. Wash water can be pumped by sludge pumps to the owner's container or line for disposal or treatment. Filters or other separation may be required for rust scale and other debris.

The floor may then be detailed by squeegee and rags as required to remove visible oil and oily stains from tank surfaces.

The problems associated with the Sludge Fluidization/Removal Method in general and the Cutter Stock technique in particular include:
Inefficient and time consuming (up to 3 Months for 110 Meter Tank)
Adds substantial volume, treatment time, cost and logistic transfer problems.
Heat Transfer is inefficient.
Heat loss results in re-solidification of sludge and creates pumping, circulation and solids separation difficulties.
Addition of cutter stock impacts physical and chemical characteristics of recovered crude oil, fuel oil, slurry oil, etc.
Process safety concerns due to increased flammability and organic emissions.
Results in high volume of cutter stock that may require re-refining to remove dispersed sludge.

Sludge Excavation

The secondary method conventionally used for the removal of sludge is the Sludge Excavation/Removal Method. In general, this method relies on the use of manual or mechanical methods to physically collect, excavate and remove the sludge from the tank in its existing condition. This method is time consuming, labor intensive and expensive. The personnel working within the tank are exposed to potential health risks as well as possible injury. Despite these drawbacks, manual removal is the only conventional removal mechanism for some types of tank bottom sludge conditions. Even when the previously discussed conventional methods are employed, the sludge is often not rendered sufficiently fluid by conventional methodology to be pumped out of the tank and at least some portion must be manually removed.

The problems associated with the Sludge Excavation/Removal Method include:
Inefficient, time consuming (up to 6 Months for 110 Meter Tank) and expensive;
Increases process safety concerns due to the requirement for working for extended periods of time in a confined space;
May Result in high volume of waste requiring disposal.

All of the previously discussed conventional sludge removal methods share a common shortcoming: a substantial decrease in storage tank utilization rates due to the inability of conventional methods to predictably complete tank cleaning operations, and return the capital asset (storage tank) to service in a repeatable efficient and cost effective manner.

Recirculation

The inventor of the present application has been developing techniques for recirculating the material pumped out of the tank during sludge removal, to further mobilize sludges to the suction point. FIG. 2 shows a petroleum storage tank and cleaning system 200 in which such approaches can be conducted. For purposes of this discussion, we will assume that storage tank 102 has been in hydrocarbon storage operation for a period of time (e.g. several years) without a cleaning operation having been conducted. During normal storage operations, petroleum oil can be pumped into the tank through inlet 203 and then out of the tank through system discharge 116. A layer of sludge 104 has thus built up on the bottom of the tank. Trapped water 222 can also be entrained with the sludge. When a decision is made to clean tank 102, the tank can then be taken off-line from normal storage operations. Tank 102 can first be emptied of free flowing oil by discharging the oil through side discharge 208 using pumping system 206 to pump the oil to a designated location through system discharge 116. (Note that this pumping system 206 may be different from the facility's primary pumping system, which is not shown.)

One cleaning technique can be to leave some of the free flowing crude oil in the tank as shown in FIG. 2 as bottom fluid pool 114. Pumping system 206 can then pump the fluid from pool 114 through side discharge 208, through recirculation line 216, and into device 214, which can be a spray or jet nozzle or series of such nozzles. Because of energy of the fluid flow emerging from the nozzles, the sludge can be “mobilized” as particles and chunks of sludge which are dislodged and/or partially dissolved away from the main sludge layer. The mobilized sludge can work its way to the bottom pool 114 and be pulled into side discharge 208 to become part of the recirculation fluid passing through recirculation line 216. Alternatively, the recirculation can be directed through a side entry into tank 102 to device 214 as alternate recirculation line 216A. By continuing the recirculation and spraying/jetting, the sludge layer can be at least partially reduced and incorporated into the re-circulating fluid, without addition of chemicals or other fluids. At some point during recirculation, a decision can be made to remove the re-circulating fluid containing the incorporated sludge particles and chunks from the tank by pumping it out of system 200 through system discharge 116. Such particles and chunks can be large, quite hard, and very slow to dissolve, if they dissolve at all. The chunks can settle and plug or partially plug fluid flow equipment and lines, causing pumping, spraying, jetting, and other fluid flow problems.

Another cleaning technique can be to perform the cleaning operation as just described but to heat the re-circulating fluid using a heat exchanger such as exchanger 219. Heating can help soften the sludge by making it a partially-fluid semi-solid to allow it to flow. Heating the re-circulating fluid can result in an increase in hydrocarbon vapor pressure in tank headspace 205A which can create and/or increase the hazards associated with such a cleaning operation.

### Methods and Systems for Operating Large Hydrocarbon Storage Facilities

The present application discloses systems and methods for cleaning sludge from the interior of tanks. Sludge on the interior surfaces of tanks is mobilized using a fluid flow stream. The mobilized sludge is mechanically sheared to reduce the size of the agglomerations or lumps in the sludge. This mechanical conditioning provides a slurry with good flow properties (up to its load limit of solids), which can be recirculated to supply all or part of the fluid flow stream.

In some embodiments (but not necessarily all), the disclosed innovations are used to remove substantially all of the sludges in a petroleum storage tank.

In some embodiments (but not necessarily all), the disclosed innovations are used to recover substantially all of the sludge in a petroleum storage tank such that the sludge can be converted into other products rather than be disposed of.

In some embodiments (but not necessarily all), the disclosed innovations are used to operate a petroleum storage tank by providing a cleaning process to be used in conjunction with a storage process.

In some embodiments (but not necessarily all), the disclosed innovations are used for cleaning oil transport tanks or holds.

In some embodiments (but not necessarily all), the disclosed innovations are used to clean oil storage tanks wherein the oil has been subjected to minimal mechanical energy input during the storage.

The disclosed innovations, in various embodiments provide one or more of at least the following advantages:
Faster cleaning;
Cheaper cleaning;
More reliable completion time estimates;
Safer cleaning;
Reduced volume of total fluids generated during a petroleum tank cleaning operation;
Reduction or elimination of the need for heating;
Reduced usage of chemical additives during a petroleum tank cleaning operation;
Reduced total cost of additives and diluents during cleaning;
Reduced stoppage of cleaning operations due to plugging of fluid recirculation lines;
Reduced personnel exposure and environmental impacts;
Reduced operating pressure;
Less or no in-tank detailing is required;
Standardized procedures and operating protocols designed for universal application to all tank conditions; and
Standardized process equipment systems engineered for superior and reliable performance under all tank conditions.

These and other features and advantages will be more clearly understood from the following detailed description taken in conjunction with the accompanying drawings and claims.

### BRIEF DESCRIPTION OF THE DRAWINGS

The disclosed innovations will be described with reference to the accompanying drawings, which show illustrative, non-limiting embodiments of the invention and which are incorporated in the specification hereof by reference, wherein:

FIG. 1 is one embodiment of the systems of the present innovations.

FIG. 2 is a cleaning system which shows the use of some recirculation for cleaning oil storage tanks.

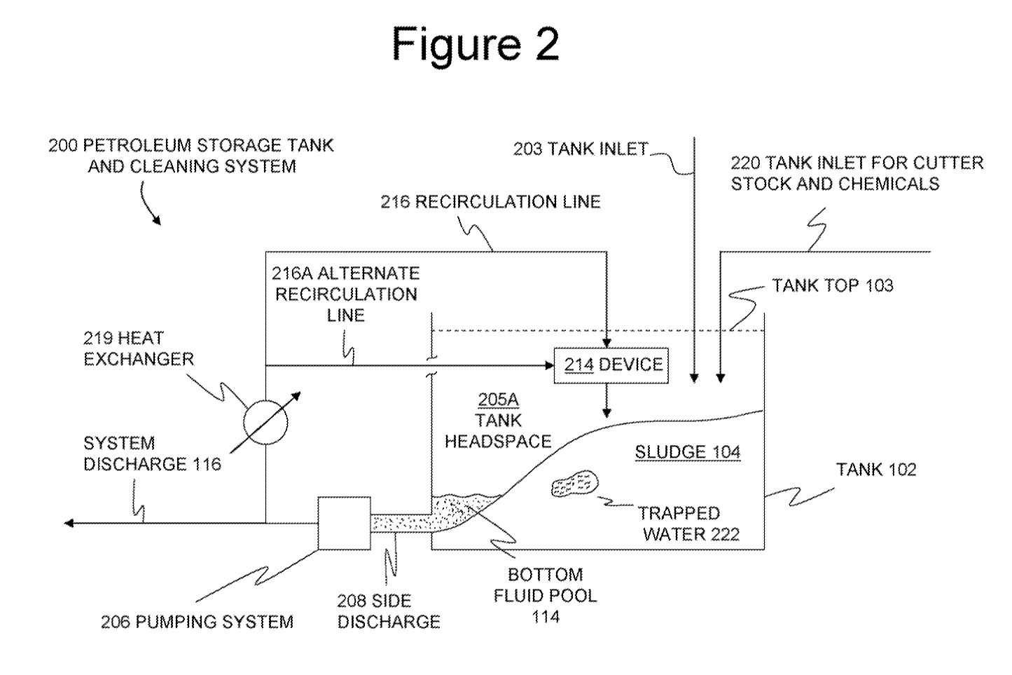

FIG. 3 shows a preferred embodiment of the methods of the present innovations.

FIG. 4 is one embodiment of a mechanical shear input system.

FIG. 5 is an alternative embodiment of a mechanical shear input system.

FIG. 6 is a preferred embodiment of the systems of the present innovations.

FIG. 7 is an embodiment of a general purpose computer in which the methods of the present innovations can be embodied to control the systems of the present innovations.

### DETAILED DESCRIPTION OF THE PREFERRED EMBODIMENTS

The numerous innovative teachings of the present application will be described with particular reference to the presently preferred embodiment (by way of example, and not of limitation).

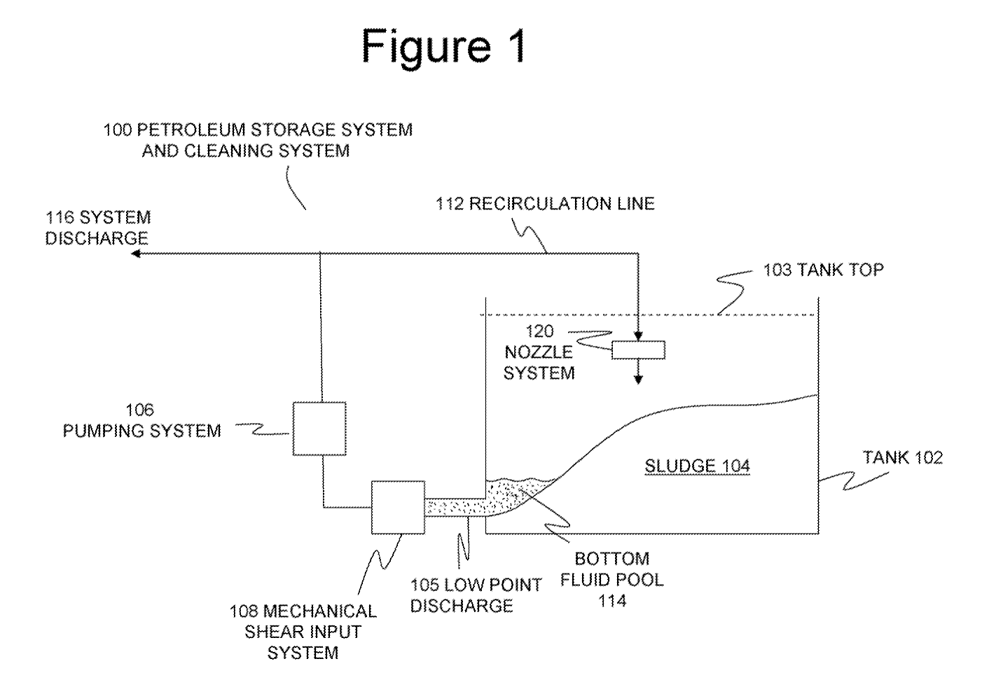

FIG. 1 shows one embodiment of a system of the present innovations. In this example, petroleum storage and cleaning system 100 comprises a tank 102 with sludge 104 on its interior surfaces (especially its bottom, as shown here). Tank 102 can be fitted with tank top 103. Fluid can be discharged from low point discharge 105. Mechanical shear input system 108 processes the stream from 105 to produce a flowable slurry.

The mechanical shear system 108 can be various types of comminution devices, as discussed below. System 108 feeds the input of pumping system 106, so that 108 and 106 are in a supercharging relationship which improves the suction lift over that which pump 106 could achieve alone.

The pumping system 106 raises the pressure of the fluid within recirculation line 112 sufficiently to provide a strong flow stream (jet) from nozzle system 120. This stream jets into the sludge 104, to help it move toward the tank discharge 105.

In the presently preferred embodiment, pump 106 is implemented by a positive displacement pump. In this sample embodiment, this is a progressive cavity pump optimized for slurry pumping. Its stator, in this example, is a high-strength elastomer, e.g. Buna-N. This pump, in this example, consumes about 25 HP. (Preferably this is supplied from a 100 HP hydraulic power supply.)

The rated peak pressure of the system, in this example, is 150 psi. The nozzle typically has an opening in the range of “1” or slightly less. Optionally, of course, the system can be operated with larger or smaller nozzle sizes, or more nozzles, or higher or lower horsepower.

After an appropriate period of recirculation to mobilize substantially all of the sludge 104 in tank 102, the discharge of mechanical shear input system 108 and/or the discharge of pump 106 can be directed through system discharge 116 to remove the extracted stream for further handling, processing, and/or disposition.

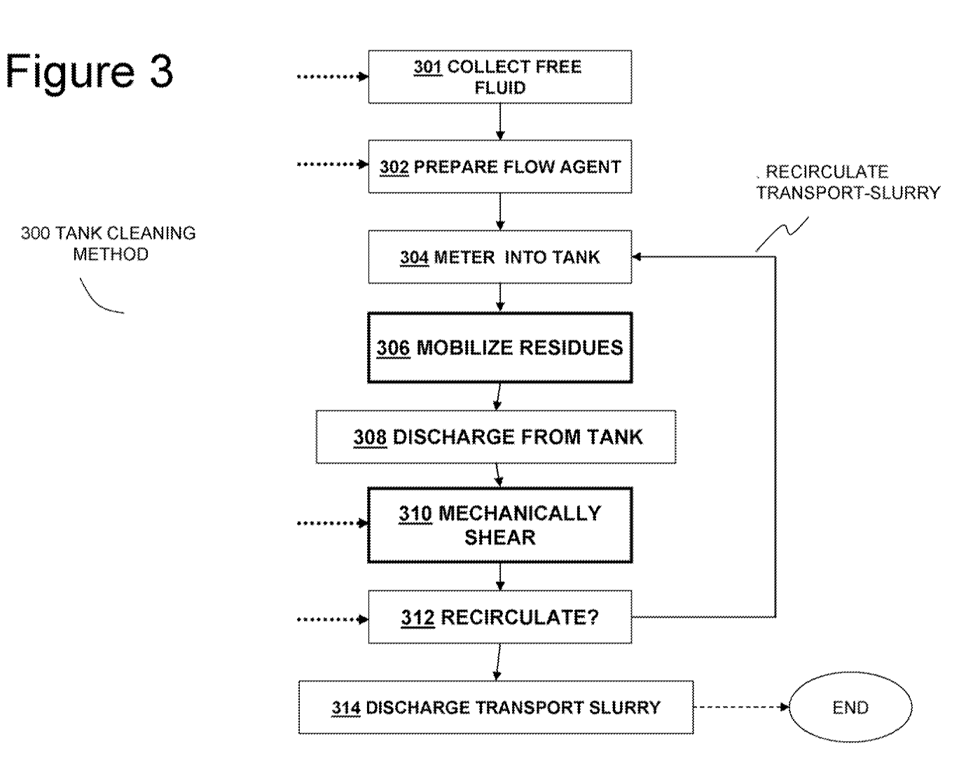

FIG. 3 shows sequencing in a preferred embodiment of the methods of the present innovations. Tank cleaning method 300 can begin with step 301 wherein free fluid is collected. Free fluid is collected to supply the quantity of liquid that will be used initially to make a Flow Agent for use in mobilizing the residue as described for FIG. 1.

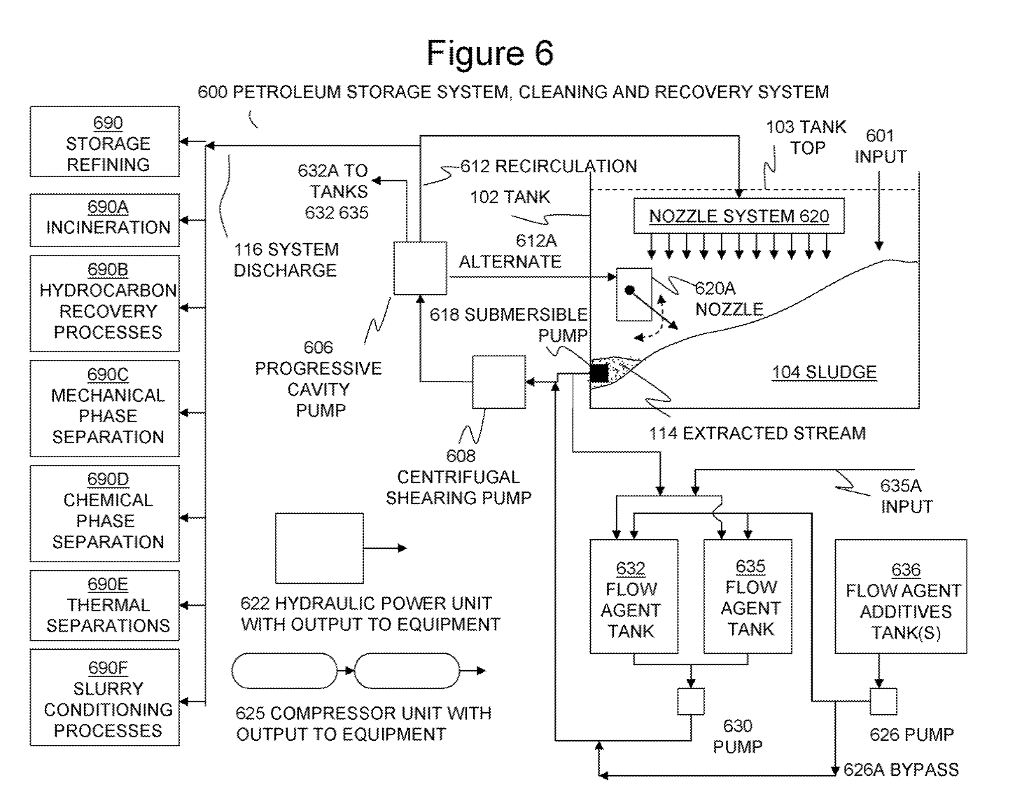

In many instances, free fluid can be collected from within the tank to be cleaned. In other situations, free fluid can be secured from sources outside the tank to be cleaned, e.g. at input 635A (shown in FIG. 6). The free fluid can be any hydrocarbon of varying viscosity or density that is pumpable, and flowable at ambient operating temperature conditions. However, it is preferable that the hydrocarbon fluid collected or secured for preparation of the flow agent have the same general characteristics of the hydrocarbon stored in the tank immediately prior to the commencement of the cleaning operations. The free fluid can also be water or other aqueous solutions, e.g. for cleaning a slop or waste oil tank. The required amount of collected free fluid can be variable.

The next step 302 in the preferred cleaning process is to prepare the flow agent. In one embodiment, the fluid from step 301 is physically conditioned through the pumping system to create the flow agent. In some versions of this embodiment no additional materials (e.g. chemicals, other fluids, cutter stock, etc.) are added to the collected free fluid. In another embodiment, such materials, collectively identified as “flow agent additives”, are added to the collected free fluid via input 635A. Either one or a plurality of materials can be dosed into the collected free fluid to create the flow agent. The materials can be dosed into the collected free fluid at the appropriate efficacious dosage level to achieve the specific effect of the flow agent additive. for example, the flow agent additive can increase or decrease the viscosity and/or yield value (e.g. solids-suspending capability) of the flow agent during recirculation. Alternatively or additionally, the flow agent additive can assist in loosening the sludge from the surfaces of the tank. (This can be done by using, for example, a surface active agent or a friction modifier). Alternatively, the material can dissolve or partially dissolve the sludge or particular components within the sludge such as waxes, asphaltenes, and paraffins.

The next step 304 in the process, in this embodiment, is to meter flow agent into the tank to be cleaned. Typically, only one tank is cleaned in a given operation. Alternatively, one skilled in the art can appreciate that with the appropriate hardware, a plurality of tanks can be cleaned simultaneously. The metering of flow agent can be made using a pumping system (such as system 106) and a conduit for the fluid into the tank (such as recirculate line 112) as illustrated in FIG. 1. In one embodiment, the pressure of the flow agent is increased using a pumping system and then discharged through a specifically-designed tank cleaning nozzle or nozzle system.

The next step 306 in the process can be to mobilize the sludge within the tank. A preferred embodiment of the present invention is to use the pressurized flow agent as a high velocity jet or spray directed at the sludge to disrupt it, break it apart, and/or cause it to flow, either as a mass or in discrete particles or chunks, or various combinations there of. The impact of the jet on the sludge may also cause the mass of sludge itself to flow towards the low point more than it would have otherwise. In addition to these modes of transport, the flow agent can also carry particulates and suspended sludge. Specialized nozzle systems installed within the tank (top, side, within a tank access way, or combinations of such locations) can be used to achieve the mobilization. Various types of configurations of such nozzles can be utilized, including rotating, articulated, and/or multi-directional effects. For example, the “Scanjet” model of nozzles is presently preferred for achieving such effects. “Scanjet” tank nozzle systems are available from Scanjet Marine AB, Gamlestadsvägen 18A, SE-402 51 Göteberg, Sweden. Another embodiment can be to direct the flow agent through a hose connected to a tank cleaning robot which can move about the interior of a tank. The slurry formed by the flow agent in combination with the mobilized sludge is referred to as the “sludge transport slurry”.

The next step 308, in the presently preferred embodiment, is to discharge or remove the sludge transport slurry from the tank. This step can be achieved from a single discharge, or from multiple discharge ports located at or near low points in the tank. Because the sludge transport slurry maintains flowability and suspension power for the sludge solids, the discharge port or ports do not easily clog. (Otherwise this could readily occur, e.g. due to residue solids falling from suspension and building blockages within the associating piping or hoses). As the sludge level in the transport slurry builds, the sludge can become part of the flow agent itself, as described below. The incorporated material, whether dissolved, partially dissolved, suspended or dispersed, can work to increase the viscosity and yield value of the transport slurry.

The next step 310, in the presently preferred embodiment, is to mechanically shear the discharged sludge transport slurry prior to recirculating it back into the tank. Mechanically shearing provides several important benefits.

1) Scale from the interior surfaces of the tank (or from other upstream equipment) can dislodge into the flow agent. Such scale can clog the nozzles used to mobilize the sludge or damage equipment in the recirculation system. Thus such scale would preferably be removed to reduce the incidence of clogging. Scale filters could be used but such filters would quickly plug with suspended sludge (or specific components within the sludge) and require frequent cleaning. Thus, for a first effect, the present innovations can utilize mechanical shearing of the sludge transport slurry to reduce the particle size of the scale without having to remove it.

2) A second effect of mechanically shearing the sludge transport slurry can be to reduce the particle size of the non-metallic non-hydrocarbon residues such as mud, sand or silt which can exist as hardened clumps which can clog or damage equipment if allowed to recirculate.

3) A third effect of mechanically shearing the sludge transport slurry can be to reduce the size of the hydrocarbon agglomerations (e.g. waxes, asphaltenes, paraffins, and other settled or precipitated petroleum components). Reducing the size of agglomerations can assist in avoiding the clogging of the mobilization nozzles. It also can assist in suspending and/or dispersing the hydrocarbon residues into the sludge transport thereby increasing the slurry's solids suspension and/or carrying capacity.

4) A fourth effect of the mechanical shearing of the sludge transport slurry can be that interior points of the hydrocarbon lumps or agglomerations are exposed to the surrounding fluid. Thus the mechanical shearing, by breaking large particles and/or opening up agglomerations, exposes the interiors of these particles and agglomerations to the surrounding fluid. This can allow the surrounding fluid to impinge on more area, and hence perform its physical or chemical action more effectively, and thereby transport the mass of the particles and agglomerations more efficiently. Specific physical or chemical actions imparted by the surrounding fluid can include partial solubility of certain organic sludge components due either to the properties of the fluid itself (e.g. oil as a solvent) and/or through the action of “flow agent additives” such as, but not limited to, solvents, fluidization agents, surface active agents, dispersants, friction modifiers and emulsifiers. Note that reducing the particle size of the agglomerations or lumps in the sludge can alternatively be stated as a reduction of the peak distance from interior points within the residues to the surrounding free-flowing slurry. By increasing the particle size distribution or dispersion of the sludge, more surface area comes in contact with the flow agent thereby making the chemical or physical impact of the flow agent on the sludge more efficient.

5) another benefit of providing a well-conditioned slurry is that it will be somewhat denser than the corresponding pure liquid phase. Recall that the sludge materials were largely the result of gravitational separation, so their density is predetermined to be higher than that of the minimum density of the liquid which has resided in the tank. Since the slurry is denser, a jet at a given volumetric flow rate will carry more kinetic energy. Since the jet has more impact, it will have more benefit in mobilizing the sludge. This is compounded by the ability to use a denser liquid phase, in various embodiments, instead of the lighter cutter stock used in conventional sludge removal methods.

The aforementioned effects were not presented in any order of importance or preference.

The next step 312 in the preferred embodiment is to recirculate the sludge transport slurry back into the tank for further mobilization and removal of the sludge in the tank. By continuously recirculating the sludge transport slurry through line 112, the residue content (e.g. weight or volume percent) in the slurry can increase until a substantial amount of residue has been either dispersed, suspended, or partially solubilized in the pumpable recirculating sludge transport slurry. During such recirculation, extra flow agent additive inputs can be made to adjust for changes in the properties of the sludge transport slurry. For example, the viscosity can build to too high a level. Thus, a viscosity reducing additive can be added, e.g. through line 635A (shown in FIG. 6). Adding the input prior to mechanical shearing can have the added effect of intense mixing of the additive into the flow agent or the sludge transport slurry as aided by the high shearing action present in mechanical shearing actions. This intense mixing of the flow agent, sludge, and flow agent additives can result in reduced usage of such materials.

Step 312 is conditional, as shown by the question mark. A decision whether to recirculate or to discharge the slurry can be made based on a number of criteria. First, discharge should occur before the viscosity of the slurry increases to the point where the nozzles in the mobilizing jets can be clogged (or experience excess pressure drop). Second, discharge should occur before the pumping action of the recirculation loop can be impaired due to slurry viscosity increasing to the point that the pumps cavitate, e.g. become starved for in-feed fluid. Third, the recirculating slurry should not be allowed to become so thick (and thixotropic) as to not efficiently flow into the tank discharge port or low point of the tank.

At the end of the cleaning process the laden sludge transport slurry will typically be pumped off to system discharge 116.

The next step 314 of the present innovations is to discharge the slurry from the tank. As discussed above, the bottom pool 114 is connected to the intake of shear device 108, either through a suction line or through a submersible pump.

After the last discharge of recirculating slurry, a final rinse with oil or water can be performed. The decision whether to make a final rinse will be determined by the plans for the tank; for example, if floor inspection and repair is planned, complete cleaning of the floor may be needed. In other cases the sludge removal process may be carried out merely for mitigation, without using final cleaning and tank entry.

If final rinse is desired, a prepared Flow Agent (or water) for final rinse is pumped into the tank through the nozzle(s). This flow agent is preferably not circulated: instead, the slurry or wastewater is pumped to discharge. Multiple iterations can be conducted to achieve removal of substantially all of the residue.

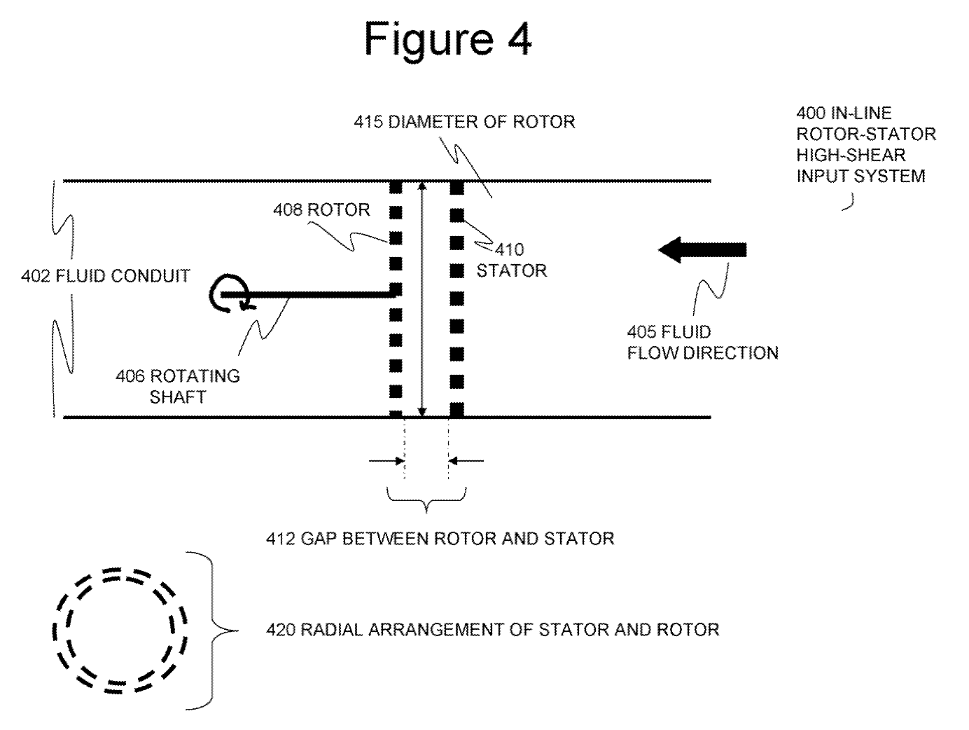

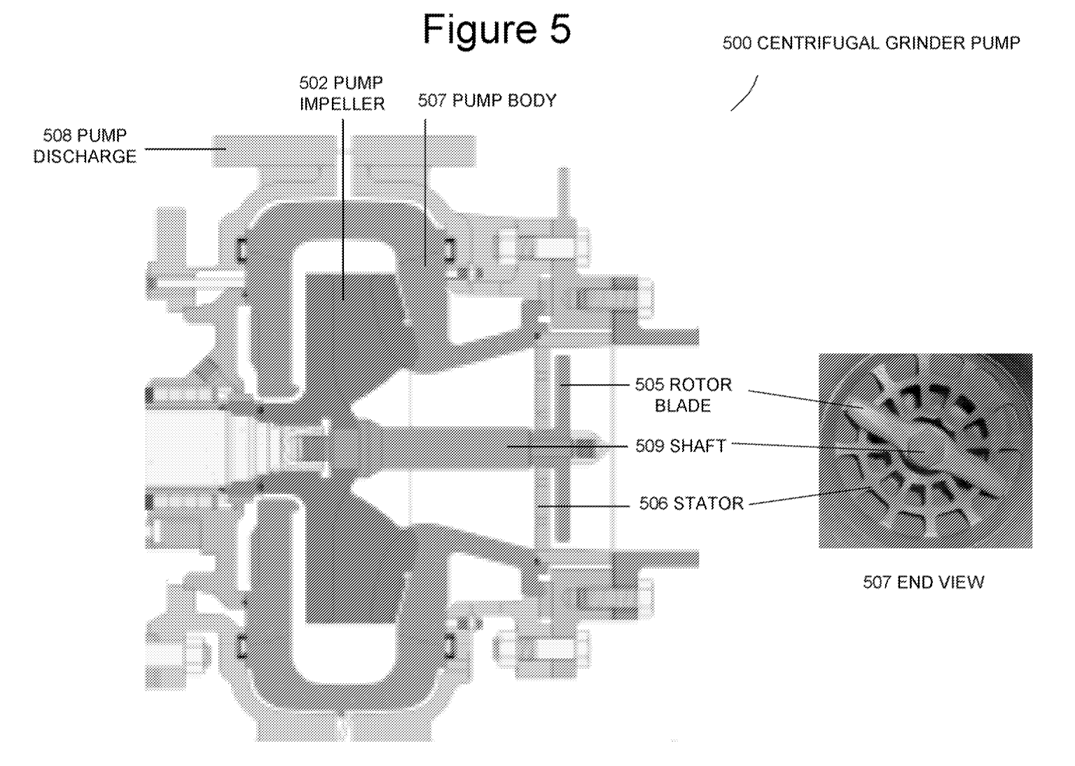

FIG. 4 shows a sample embodiment of mechanical shear input system 108 as used in mechanical shear step 310. The embodiment is an in-line rotor-stator high shear input system 400 that can be a stand-alone equipment component or an element of a different equipment component (such as shown in FIG. 5). System 400 is contained within fluid conduit 402. Fluid conduit 402 can be a fluid pipe or a fluid pump housing, for example. Fluid direction 405 is shown as passing first through stator 410 and then through rotor 408, but the opposite can also be used. Rotor 408 is a rotating member having passageways for fluid to pass through to the stator. Rotor 408 can also be a simple or multiple cutting or chopping blade, e.g. a “rotor blade”. Rotor 408 can also comprise rows of teeth or sharp members for efficient shearing. Rotating shaft 406 is attached to rotor 408. Shaft 406 can be driven by any suitable means of power. Shaft 406 can spin at various revolutions per minute (“RPM”) ranging from just above zero to as high as the mechanical limits of the particular equipment will allow. rotor 408 is positioned close to stator 410 as depicted by gap 412. Gap selection can be made with reference to the mobilization nozzle size and passageway diameters in the rotor and stator.

Reference 420 shows an alternative radial arrangement of rotor and stator rather than the linear arrangement just described. One skilled in the art of high shear mixing can appreciate various configurations and multiple combinations of rotor-stators as can be applied to the present innovations.

FIG. 5 shows a sample alternative embodiment, using a shearing pump. In this embodiment the mechanical shear input device is implemented by a centrifugal shearing pump 500. Rotor blade 505 is attached to rotating shaft 509. Stator 506 is attached to pump body 507. Flow agent with suspended residue can pass through the rotor blade and stator arrangement and can be sheared by the action of the rotor-stator arrangement. Pump impeller 502 and pump body 507 work together to provide the suction to pull the flow agent through the rotor-stator arrangement and out through pump discharge 508.

In the currently preferred implementation, the mechanical shear system 108 is implemented by a Vaughan chopper pump. In addition to providing liquid flow and pressure within the system, the chopper pump is capable of chopping and reducing solids that are entrained within the liquid. This pump uses an impeller with cupped and sharpened impeller blades which turn across the stationary cutter bar at a close tolerance, creating a shearing effect to reduce solid size.

The mechanical shear input system 108 not only breaks solids down, but also disperses soft or semi-soft agglomerations, and generally performs a mixing action on the slurry passing through. As discussed above, the combination of these effects helps to improve the flow characteristics of the sludge transport slurry which is mechanically conditioned thereby. The increase in these effects over a simple centrifugal pump is difficult to quantify, but those of ordinary skill will recognize that systems 108 as described impart much more turbulence and mixing than a centrifugal pump of equal horsepower.

In a sample implementation, a 5 HP hydraulic motor drives the first stage pump 108, which is implemented by a Vaughn chopper pump.

FIG. 6 shows further details of a preferred embodiment of the system of the present innovations for operating and cleaning petroleum oil storage tanks. The operation of petroleum storage system/cleaning and system 600 can be conducted as follows. The tank 102 can normally receive and store and discharge black oil (e.g. crude oil or fuel oils) using suitable inlets and outlets of the tank (not shown). Such oil can be sent to further storage and refining 690. (Note that the facilities pumping systems which normally transport oil from one location to another are not shown. The facilities pumping system will have stripped the tank, to within its capabilities, before the cleaning operation starts.) A decision can be made to remove or reduce sludge 104 which has accumulated over time. To begin the cleaning operation, if water (not shown) is present in the tank to be cleaned, the water can be removed and pumped out of the tank from the low point of the tank. This can be achieved by placing a submersible “sump” pump 618 at the low point of the tank with a hose or pipe discharging to the suction side of a centrifugal shearing pump 608. Alternatively, the suction of a centrifugal shearing pump 608 can be drawn directly from the low point or a water draw or sump. The shearing pump can discharge the water into the suction side of a progressive cavity pump 606. The progressive cavity pump can discharge the water from system 600 to a location for recovery or disposal of the water.

The next step can be to collect or secure an adequate quantity of free fluid for preparation of the flow agent. The free fluid can be any hydrocarbon of varying viscosity or density that is pumpable, and flowable at ambient operating temperature conditions. It is preferable that the hydrocarbon fluid collected or secured for preparation of the flow agent have the same general characteristics of the hydrocarbon stored in the tank immediately prior to the commencement of the cleaning operations. For example, if a crude oil tank is being cleaned, crude oil should be used. If it is a fuel oil tank being cleaned, fuel oil should be used. Options for collection or securing of the free fluid for creation of the flow agent can include the collection of hydrocarbon fluid from the tank to be cleaned (e.g. in-situ recovered oil, not shown in FIG. 6); or securing hydrocarbon fluid from an external source which can be introduced directly to flow agent tanks 632 or 635 through input 635A. For collection of in-situ recovered oil to prepare the flow agent, the process can be to collect the hydrocarbon fluid from the tank bottom sludge in the tank to be cleaned. From a low point in the tank, the free hydrocarbon fluid can be pumped to the flow agent tanks 632 and 635 until they are full, and then any excess can be directed to a location outside of the cleaning operation. (Two flow agent tanks are shown in FIG. 6, but any number of flow agent tanks can be employed in the present innovations.) This can be achieved by placing submersible pump 618 at the low point inside of tank 102 with the pump discharge to the suction side of centrifugal shearing pump 608. Alternatively, the suction of centrifugal shearing pump 608 can be drawn directly from the low point or a water draw or sump as previously described. The discharge of centrifugal pump 608 is directed to the suction side of progressive cavity pump 606, through the pump, through line 632A, and to flow agent tanks 632 and 635. For collection of externally-sourced oil to prepare the flow agent, oil from an appropriate source can be pumped into the flow agent storage tanks via input 635A. This option can be necessary if no pumpable, flowable free fluid can be recovered from the tank during this initial phase.

The next step can be to prepare the flow agent. The flow agent can be prepared by conditioning the hydrocarbon fluid collected from the tank or provided from an external source. The flow agent is the fluid used to motivate the tank bottom sludge from anywhere inside the tank to the pump suction pickup points such as the sump, low point in tank, etc. The flow agent can include a surface tension reduction fluid or friction modifier that allows the sludge and solids to flow. Conditioning of the collected hydrocarbon fluid includes but is not limited to mechanical conditioning of the hydrocarbon fluid, the addition of flow enhancing chemical formulations or compounds (collectively referred to as flow agent additives) to the hydrocarbon fluid, or the addition of any combination of hydrocarbons and/or flow agent additives to the hydrocarbon fluid. To prepare the flow agent by mechanical conditions, the hydrocarbon fluid staged in flow agent tanks 632 and 635 can be pumped from the discharge of the tanks to the suction side of centrifugal shearing pump 608, through the centrifugal shearing pump, into the suction side of the progressive cavity pump 606, through the progressive cavity pump and back to the flow agent tanks. The flow agent can be circulated as required to adjust its flow properties via mechanical conditioning. To prepare the flow agent by adding conditioning chemical or chemicals to the hydrocarbon fluid staged in the flow agent tanks, the conditioning chemicals or combination thereof, referred to as “flow agent additives”, will be staged in additional tanks such as tank(s) 636. The chemicals are pumped from the tank(s) using a chemical feed pump 626, to the flow agent tanks.

The next step can be to begin the circulation and removal of the sludge 104. The circulation of tank bottoms sludge can include the controlled pumping or “metering” of the prepared flow agent under pressure through the circulation nozzle system 620 or nozzle 620A directed into the tank bottoms sludge within the tank. The action of the flow agent on the sludge solids can be to enhance sludge solids flow to tank collection areas for circulation suction pickup; and the mechanical commingling of the flow agent and the sludge solids in the pumping and nozzle delivery system to create a “sludge transport slurry”, wherein the slurry has increased solids carrying capacity as recirculation is continued through line 612 or alternate 612A to nozzle 620A. Note that system 620 can be articulated (e.g. automatically sequenced through a series of nozzles to provide mobilizing action for the interior surfaces of the tank), whereas nozzle 620A can be a rotating multi-directional nozzle to also provide such coverage.

To achieve the recirculation and removal, flow agent, staged in the flow agent tanks 632 and 635 can be metered into tank 102 by means of the progressive cavity pump 606. The flow agent is pumped under pressure to the automatic articulated circulation nozzles, which can be attached to the tank at a man way on the side or top 103 or the tank 102. The flow agent can be jetted into the sludge 104 in a coherent stream. Stream lengths of 90 feet can be achieved. The flow agent can impact the sludge 104, causing it to flow to the low points in the tank where the flow agent and sludge are then picked up by pump suction (either pump 618 and/or pump 608 suctions), commingled and conditioned through the pumping system thereby creating a sludge transport slurry which is then pumped under pressure back into the tank through the circulation nozzles where the slurry picks up more solids, flows to the low points in the tank and is again picked up by pump suction for additional circulation. The circulation phase of the cleaning operation can be completed and discontinued when the sludge transport slurry circulation no longer can accumulate additional solids. The slurry can then be pumped out of the system to a designated location or to optional secondary processing equipment systems for phase separation and/or treatment.

The finished sludge transport slurry can also be pumped to optional secondary processing equipment systems for phase separation and/or treatment. Secondary process equipment systems include any mechanical 690C, chemical 690D or thermal process 690E complete with the requisite process support equipment to separate, modify, eliminate, treat or recover any component or combination of components within the sludge transport slurry or the slurry itself, such as hydrocarbon recovery processes 690B. some examples of secondary process equipment systems include mechanical/chemical phase separation systems, gravity phase separation systems, and thermal desorption or incineration 690A systems. Further sludge transport slurry conditioning processes 690F can also be employed. If the optional secondary process is capable of efficient solids removal from the sludge transport slurry at an acceptable processing rate, the resulting hydrocarbon liquid from the solids removal process may be circulated back to the tank to be used in the creation of additional flow agent. One skilled in the art of hydrocarbon recovery processes or slurry processing will appreciate the types and kinds of processes or sub-processes that can be employed to further process the recovered sludge and flow agent in which they are contained.

Up to this point in the cleaning operation, all steps can be accomplished without entering the tank and without workers working inside the tank (other than to set the submersible pump 618 if required, which would be done with the workers using self-contained breathing apparatus).

Upon the completion of the sludge transport slurry circulation and discharge phase, entry can be made into the tank to initiate a sludge wash-down phase through the continued removal of any remaining tank bottoms sludge. Sludge wash down can involve the controlled pumping or metering of the prepared flow agent under pressure through a manually articulated wash down nozzle and into the remaining tank bottoms sludge within the tank; the action of the flow agent on the sludge solids to enhance sludge solids flow to tank collection areas for suction pickup. during the sludge wash-down phase, the flow agent, staged in the flow agent tanks 632 and 635, can be metered into the tank by means of the diaphragm pump (not shown) through a wash down nozzle which is manually articulated (not shown). The slurry can then be pumped out of the system to a designated location or to optional secondary processing equipment systems for phase separation and/or treatment.

The final step can be a water wash down phase, if required. This step includes the use of surfactants or other cleaning chemicals if required.

The systems of FIG. 6 can also include hydraulic power unit 622 to supply hydraulic power to drive the various pieces of equipment (such as pumps) and air compressor unit 625 to supply pneumatic power to also drive pieces of equipment (such as air-powered diaphragm pumps or control actuators)

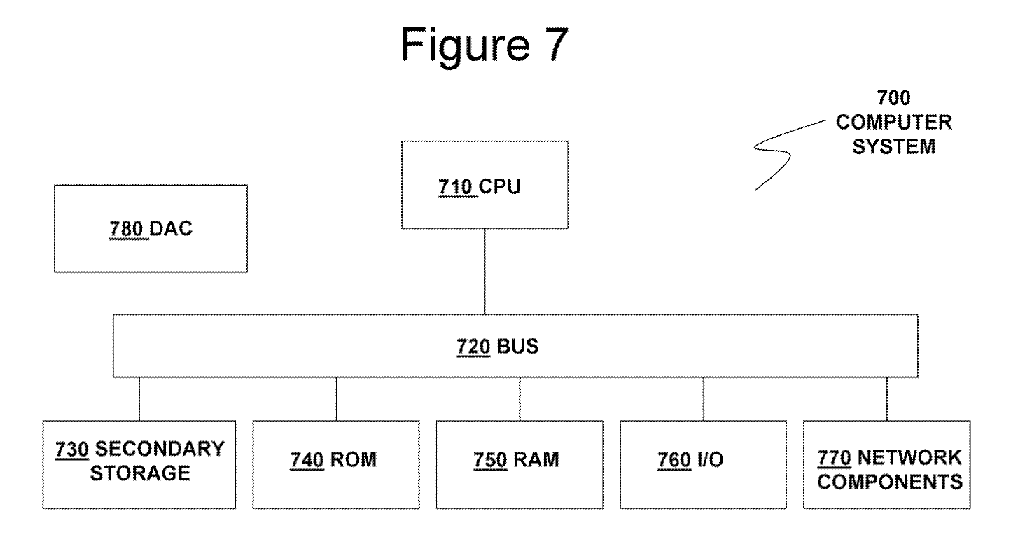

Optionally, the methods and systems described herein can be implemented and controlled using a general-purpose computer or laptop computer or microprocessor system, or an external computing and analysis system, in addition to being embodied in manufacturing control hardware, as long as such embodiments possess adequate computing resources, memory, and communication capacity to perform the necessary operations requested of them. FIG. 7 shows one embodiment of such a computer system 700 for implementing one or more embodiments of the methods and systems of the present innovations. System 700 includes central processor unit (CPU) 710 which can communicate with various system devices via communications BUS 720. CPU 710 can execute codes, instructions, programs, and scripts which it accesses from various disk based systems which can be secondary storage 730, ROM 740, RAM 750, or the network communication components 770. The set of instructions to CPU 710 can comprise input instructions that receives data or models from an external system. Optionally, various System devices can include memory devices such as secondary storage 730, read only memory (ROM) 740, random access memory (RAM) 750. System 700 can connect to other systems such as the systems of the present innovations via input/output (I/O) components 760 and network or communication components 770. Optionally, the signal outputs from system 600 to actuators and flow control elements can be converted from a digital to an analog signal by a digital to analog converter (DAC) 780. Optionally, additional signal conditioning can be conducted on system 600 output signals to appropriately communicate with various control elements and actuators.

Facilities Operation

Use of the above techniques benefits the economics of storage operations. This can also be advantageous for related operations, such as refining, transport, and terminal storage, which are commonly performed together with large-volume storage.

One advantage is that the rapid turnaround time of the above cleaning procedures improves the efficiency of utilization of the storage facility. A more surprising advantage is that the above procedures reduce the uncertainty of time requirements for cleaning, and this permits tighter scheduling without the cost of scheduling errors. For example, suppose that an import terminal operator is expecting heavy arrivals after 30 days, and needs a currently-empty tank to be available for filing at that time. If prior cleaning methods, with their potential for unexpected delays due to conditions inside the tank, forecast completion within 28 days, this forecast cannot be relied on.

In turn, this implies that facilities maintenance can be worked into scheduling more efficiently. Thus a facilities operator can (if it wishes) reduce the desired time between tank cleanings, e.g. from 8 years to 5. This in turn means that routine maintenance of tanks can be optimized for a more frequent inspection schedule if desired. For example, when a tank floor is inspected, the inspection can be more tolerant if the required remaining service life is lower.

The facility also benefits from reduced risk of spills, and more verifiable tank condition. Government authorities may require inspections which are more frequent than engineering considerations would require, and the inventions described above can reduce the cost of compliance.

Another advantage of the disclosed systems is reduced use of high-pressure pumping. Many facilities (especially refineries) have stringent regulations on high-pressure fluid flows, i.e. any flow above 150 psi, because of process safety concerns. The disclosed inventions provide the benefits of a positive displacement pump for pressure washing, without the risk of pressure spikes which will otherwise occur when a positive displacement pump is driving flow into a clogged nozzle.

According to a disclosed class of innovative embodiments, there is provided a method of removing sludge from a tank, comprising the actions of: jetting a sludge transport slurry onto the sludge, to thereby stimulate movement of the sludge towards a pickup; collecting slurry and/or sludge at said pickup, and mechanically processing it to maintain flowability of the resulting slurry; and pumping said resulting slurry to provide said sludge transport slurry.

According to a disclosed class of innovative embodiments, there is provided a method of removing sludge from a tank, comprising the actions of: A) transferring the sludge with an inline stage which disperses agglomerations into a resulting slurry, and which also supercharges a positive displacement pump; B) metering flow agents into the material in relation to flow characteristics; and therefrom C) directing said slurry through a nozzle system towards the sludge in the tank, to thereby mobilize sludge which is transferred by said step (A); whereby the sludge, when converted to said slurry, can be removed from the tank.

According to a disclosed class of innovative embodiments, there is provided a method of cleaning tanks, comprising the actions of: mobilizing sludge in a tank, using an introduced flow stream, to thereby provide an extracted stream containing said mobilized sludge; mechanically shearing at least a portion of said extracted stream, to thereby reduce the peak distance from interior points of said mobilized sludge from surrounding free fluid; and pumping said extracted stream, after said shearing step, with a positive displacement pump.

According to a disclosed class of innovative embodiments, there is provided a method of cleaning large oil tanks, comprising the actions of: a) removing free fluid from the tank; b) mobilizing sludge, using an introduced liquid, to thereby provide an extracted stream, until the sludge is substantially removed from the tank; wherein said introduced liquid is more than half provided by said free fluid and/or said extracted stream.

According to a disclosed class of innovative embodiments, there is provided a method of cleaning oil tanks, comprising: mobilizing sludge, using a mechanically conditioned slurry, to thereby feed an extracted stream; recycling at least part of said extracted stream, through a mechanical conditioning stage, to provide at least a portion of said mechanically conditioned slurry; and discharging said extracted stream in dependence on the flow properties of said mechanically conditioned slurry.

According to a disclosed class of innovative embodiments, there is provided a tank cleaning system, comprising: at least one fluid nozzle for mobilizing sludge in a tank, using an introduced flow stream, to thereby provide an extracted stream containing said mobilized sludge; at least one mechanical comminution device which reduces the sizes of agglomerations and lumps in said extracted stream, to thereby improve flow characteristics of the resulting slurry; and at least one pump which is downstream from said comminution device.

According to a disclosed class of innovative embodiments, there is provided a tank cleaning system, comprising: at least one fluid nozzle positioned to direct a jet of slurry onto the sludge in a tank, using an introduced flow stream, to thereby provide an extracted stream containing mobilized portions of the sludge; at least one mechanical slurry conditioning device which mechanically shears at least a portion of said extracted stream, to thereby improve flow characteristics of the resulting slurry; and at least one positive displacement pump pumps slurry from said mechanical slurry conditioning device to said nozzle.

According to a disclosed class of innovative embodiments, there is provided a tank cleaning system, comprising: an inline stage which draws material from a pickup in the tank, and disperses agglomerations therein into a resulting slurry; a positive displacement pump, connected after said inline stage in a supercharging relationship; a metering stage which meters flow agents into the material in relation to flow characteristics; and at least one nozzle which is supplied by said positive displacement pump and directs a jet onto the sludge in the tank, to thereby mobilize sludge which is transferred by said inline stage; whereby the sludge, when converted to said slurry, can be removed from the tank.

According to a disclosed class of innovative embodiments, there is provided a method of operating a petroleum storage facility, comprising: filling at least one petroleum storage tank as needed; draining said tank as needed; and, when removal of sludge from said storage tank is desired, then jetting a sludge transport slurry onto the sludge, to thereby stimulate movement of the sludge towards a pickup; collecting slurry and/or sludge at said pickup, and mechanically processing it to maintain flowability of the resulting slurry; and pumping said resulting slurry to provide said sludge transport slurry.

According to a disclosed class of innovative embodiments, there is provided a method of operating a petroleum storage facility, comprising: filling a petroleum storage tank as needed; draining said tank as needed; and, when cleaning of the storage tank is desired, after sludge has accumulated in said tank, then A) transferring the sludge with an inline stage which disperses agglomerations into a resulting slurry, and which also supercharges a positive displacement pump; B) metering flow agents into the material in relation to flow characteristics; and therefrom C) directing said slurry through a nozzle system towards the sludge in the tank, to thereby mobilize sludge which is transferred by said step (A); whereby the sludge, when converted to said slurry, can be removed from the tank.

According to a disclosed class of innovative embodiments, there is provided a method of operating a petroleum storage facility, comprising: filling a petroleum storage tank as needed; draining said tank as needed; and, when cleaning of the storage tank is desired, then mobilizing sludge in a tank, using an introduced flow stream, to thereby provide an extracted stream containing said mobilized sludge; mechanically shearing at least a portion of said extracted stream, to thereby reduce the peak distance from interior points of said mobilized sludge from surrounding free fluid; and pumping said extracted stream, after said shearing step, with a positive displacement pump.

According to a disclosed class of innovative embodiments, there is provided a methods for cleaning sludge from a large tank. The sludge from the interior of storage tanks is mobilized using a metered flow agent stream and then subjected to a mechanical comminution or high shear action, e.g. by grinding or chopping. This produces a pumpable slurry which is then recirculated back into the tank to further mobilize sludge.

According to a disclosed class of innovative embodiments, there is provided a systems for cleaning sludge form a large tank. The sludge from the interior of storage tank is mobilized using a metered flow agent stream and then subjected to a mechanical comminution or high shear action, e.g. by grinding or chopping. This produces a pumpable slurry which is then recirculated back into the tank to further mobilize sludge.

According to a disclosed class of innovative embodiments, there is provided a methods and systems for operating a facility which stores large quantities of petroleum. When the large storage tanks need cleaning or sludge abatement, the sludge from the interior of storage tanks is mobilized using a metered flow agent stream, and then subjected to a mechanical comminution or high shear action, e.g. by grinding or chopping. This produces a pumpable slurry which is then recirculated back into the tank to further mobilize sludge.

Modifications and Variations

As will be recognized by those skilled in the art, the innovative concepts described in the present application can be modified and varied over a range of applications, and accordingly the scope of patented subject matter is not limited by any of the specific exemplary teachings given. It is intended to embrace all such alternatives, modifications, and variations that fall within the spirit and broad scope of the appended claims.

The methods and systems of the present application can operate across a wide range of hydrocarbons and tank situations and conditions. One of ordinary skill in the art, with the benefit of this disclosure, will recognize the appropriate use of the methods and systems for a chosen application of a given or dynamic set of operating parameters. The methods and systems are applicable to refinery and terminal facility storage tanks up to 400 feet in diameter in heavy, black oil service (includes crude oil, fuel oil, clarified slurry oil, catalyst fines, asphalt, slop oil) and in refined white oil service (gasoline, diesel, and refined products).

Optionally, the methods and systems of the present application can be configured or combined in various schemes. The combination or configuration depends partially on the required or desired result of the cleaning and the operational characteristics of the tank or tank system being operated and cleaned. One of ordinary skill in the art of tank cleaning, with the benefit of this disclosure, will recognize the appropriate combination or configuration for a chosen application.

Of course the nozzle sizing and configurations can be widely varied. Similarly, the pressure, pump horsepower, and other fluid flow conditions can be varied. Similarly, individual pumps can optionally be replaced by parallel or series combinations.

The disclosed inventions are not only applicable to land-based storage tanks. In other applications, these inventions can be usefully applied to ships, barges, and offshore holding tanks.

In another class of embodiments, it is contemplated that tanks which hold oil-based drilling mud in offshore operations can benefit from the disclosed inventions. It is also contemplated that solids boxes in such operations can benefit from the disclosed inventions.

In alternative embodiments, as partly indicated above, a variety of final rinse or treatment steps can follow the recirculating-slurry clean.

One surprising advantage of the disclosed inventions is avoidance of overpressures. A positive-displacement pump can generate sudden overpressures if a nozzle is suddenly blocked by scale. However, by mechanically conditioning the slurry upstream of the positive-displacement pump, the risk of overpressures is substantially reduced. Nevertheless, it is also optionally possible to include pressure relief valve in the recirculation line, to avert problems due to sudden breakage of the chopper or similarly unexpected events.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a particple. The claims as filed are intended to be as comprehensive as possible, and NO subject matter is intentionally relinquished, dedicated, or abandoned.

What is claimed is:

1. A method of operating a petroleum storage facility, comprising:
filling at least one petroleum storage tank as needed;
draining said tank as needed;
and, when removal of sludge from said storage tank is desired, then
jetting a sludge transport slurry onto the sludge, to thereby stimulate movement of the sludge towards a pickup point;
collecting slurry and/or sludge at said pickup, and mechanically processing it to maintain flowability of the resulting slurry; and
pumping said resulting slurry to provide said sludge transport slurry.

2. The method of claim 1, wherein said pumping action uses a positive displacement pump.

3. The method of claim 1, wherein the tank is a liquid petroleum oil storage tank, and the sludge is composed substantially of materials originating from the liquid petroleum oil.

4. The method of claim 1, wherein said mechanically processing action uses a rotary mechanical device comprising a rotor or rotor blade and a stator.

5. The method of claim 1, wherein a first pump with a rotor and a stator is used to provide said mechanically processing action, and a second pump is used to provide increased pressure for said jetting action.

6. The method of claim 1 wherein an additive is added to said transport slurry.

7. A method of operating a petroleum storage facility, comprising:
filling a petroleum storage tank as needed;
draining said tank as needed;
and, when cleaning of the storage tank is desired, after sludge has accumulated in said tank, then
A) transferring the sludge with an inline stage which disperses agglomerations into a resulting sludge transport slurry, and which also supercharges a positive displacement pump;
B) metering a flow agent into the slurry in relation to flow characteristics of the slurry; and therefrom
C) directing said slurry through a nozzle system towards the sludge in the tank, to thereby mobilize sludge which is transferred by said step (A); whereby the sludge when converted to said sludge transport slurry, can be removed from the tank.

8. The method of claim 7, wherein said directing action uses a positive displacement pump.

9. The method of claim 7, wherein the tank is a liquid petroleum storage tank, and the sludge is composed substantially of materials originating from said liquid petroleum.

10. The method of claim 7, wherein said slurry is also sometimes sent to a hydrocarbon recovery process.

11. The method of claim 7, wherein a flow agent additive is sometimes added to said slurry.

12. The method of claim 11, wherein said flow agent additive is added to thereby maintain a particular flow characteristics of said sludge transport slurry.

13. A method of operating a petroleum storage facility, comprising:
filling a petroleum storage tank as needed;
draining said tank as needed;
and, when cleaning of the storage tank is desired, then
mobilizing sludge in a tank, using an introduced flow agent, to thereby provide an extracted sludge transport slurry containing said mobilized sludge;
mechanically shearing at least a portion of said extracted sludge transport slurry, to thereby reduce the peak distance from interior points of said mobilized sludge from surrounding free fluid; and
pumping said extracted sludge transport slurry, after said shearing step, with a positive displacement pump.

14. The method of claim 13, wherein the tank is a liquid petroleum storage tank, and the sludge is composed substantially of materials originating from the liquid petroleum.

15. The method of claim 13, wherein said extracted sludge transport slurry, after said shearing step, provides at least a portion of said introduced flow agent.

16. The method of claim 13, wherein said extracted sludge transport slurry is sometimes sent to a hydrocarbon recovery process.

17. The method of claim 13, wherein, said mobilizing action is achieved using at least one fluid nozzle, and said mechanical shearing action is achieved using a rotary mechanical device comprising a rotor or rotor blade and a stator.

18. The method of claim 13, wherein a first pump with a rotor and a stator is used to provide said mechanical shearing action, and a second pump is used to provide said pumping action, and to thereby provide increased pressure to said mobilizing action.

19. The method of claim 18, wherein said first pump is a centrifugal shearing pump and said second pump is a progressive cavity pump.

20. The method of claim 13, wherein a flow agent additive is added to said introduced flow agent and/or said extracted sludge transport slurry.

21. The method of claim 1, wherein said jetted sludge transport slurry is initially supplied from an external source of liquid hydrocarbons.

22. The method of claim 1, wherein said jetted sludge transport slurry is initially supplied from free liquid found in the tank.

23. The method of claim 7, wherein said metered flow agent is initially supplied from an external source of liquid hydrocarbons.

24. The method of claim 7, wherein said metered flow agent is initially supplied from free liquid found in the tank.

25. The method of claim 13, wherein said introduced flow agent is initially supplied from an external source of liquid hydrocarbons.

26. The method of claim 13, wherein said introduced flow agent is initially supplied from free liquid found in the tank.
